(19) United States
(12) Patent Application Publication
(10) Pub. No.: US 2006/0075111 A1
(43) Pub. Date: Apr. 6, 2006

(54) Virtual internet based PC service for households

(76) Inventors: Mosen Auryan, New York, NY (US); Eileen M. Braun, Howell, NJ (US)

Correspondence Address: BIRCH STEWART KOLASCH & BIRCH, PO BOX 747, FALLS CHURCH, VA, 22040-0747, US

(21) Appl. No.: 10/952,749

(22) Filed: Sep. 30, 2004

(51) Int. Cl. G06F 15/16

(52) U.S. Cl. 709/227

(57) ABSTRACT

A home-based terminal, or so-called bare-bones PC, includes a processor, which is capable of handling a high-speed data connection to a service provider. The home user would instruct the service provider to construct a virtual PC having user selected hardware performance characteristics (e.g. processor class, processor speed, memory storage size and speed), and having user selected software titles (e.g. word processors, spread sheets, games). The service provider would charge a subscription fee for the virtual PC, and would be responsible for installing and updating the selected software titles. Further, the service provider would be responsible for backing up data and for maintaining up-to-date virus protection for the virtual PC.

### BACKGROUND OF THE INVENTION

1. Field of the Invention

The present invention relates to home personal computers. More particularly, the present invention relates to a method of providing customizable computer resources to home users, over a high-speed connection from a remote service provider.

2. Description of the Related Art

Many households have at least one personal computer (PC). A PC has become a necessary tool for household record keeping and word processing, as well as a source of enjoyment with games and other entertaining and educational software titles. Moreover, with an Internet connection, the home-based PC is invaluable as a research tool for school projects, current news and weather, email communications and shopping.

Unfortunately, there is a down side to PC ownership. First, it is difficult to understand the technology, which drives a PC. Before buying a PC for the home, a consumer usually spends a great amount of time and effort attempting to understand PC concepts, such as processor classes, processor speeds, video driver cards, memory types, hard drive speeds and sizes, etc. Moreover, consumers must spend time researching the feature specifications for each of the various PCs in the market place, traveling to a PC dealership, dealing with sales people, and of course, the expense involved in the actual purchase of the PC.

The typical, perpetual cycle of PC ownership starts with the above-mentioned research, making a purchase of a PC that almost always has more functionality than what a consumer can understand and/or utilize, using the PC happily for about two years, and then realizing that the PC's hardware has become obsolete, and will no longer run the current software at an acceptable speed. The PC is disposed of, and the cycle starts again, with research into buying a new PC.

Although the PC has a useful life, in the above example, of approximately two years, these two years also have drawbacks. First, PC owners must load some, if not all, of their desired software onto the home PC. Loading software is very time consuming. Further, loading software is extremely difficult to some home PC users, because they do not understand the installation process and the questions asked by the software during the installation process. For example, often times the home PC user does not know the answers to the software installation assistant or wizard's questions regarding the video driver specifications, available ports or interrupt numbers, memory usage specifications, etc.

Second, PC owners must constantly carry the burden of updating the software applications that are utilized on their home PC. From time to time, software manufacturers offer, via Internet download, DVD, CD or disc, performance updates to ensure that the home PC software is performing at top speed with the most up-to-date features, functions and compatibility. Beside the performance updates, some software manufacturers must constantly (sometimes weekly) offer patches, fixes, and other such safety updates to protect the home PC against viruses, worms, and other such hacker attacks. Also, home PC owners need to backup their stored data periodically to reduce the potential loss of valuable data due to operator mistake or a hacker's attack. Again, backing up data is a time consuming process.

As discussed above, home PC ownership has several drawbacks. To address a few of these drawbacks, a person might rent a PC from a retailer. However, renting a PC does not solve the drawbacks associated with installing and maintaining software, and backing up data. Further, renting a PC is often times more expensive, on a per month basis, than purchasing a PC and owning it for approximately two years.

In the business environment, there is a solution to several of the drawbacks mentioned above. Often terminals or workstations are provided at many employees' desks. The terminals are connected to a central computer which has a large memory storage capacity, and which has software available for the employees to run. An IS department is responsible for updating the software, periodically backing-up data and ensuring that anti-virus and firewall software remains up to date.

However, as far as the Applicants know, the above-mentioned business computing structure has heretofore not been offered to the home market. Moreover, in the above-mentioned business structure, each of the employees' terminals has identical computing powers. In other words, there is no option for the users of the terminals to custom configure a virtual PC with desired performance characteristics. Also, there is no option configure a virtual PC with user selected software titles.

### SUMMARY OF THE INVENTION

It is an object of the present invention to address one or more of the drawbacks of the background art.

It is an object of the present invention to provide personal computer services to home users without the burden of purchasing expensive equipment.

It is an object of the present invention to provide personal computer services to home users without the burden loading and configuring desired software onto a home-based PC.

It is an object of the present invention to provide personal computer services to home users without the burden updating software and hardware to keep the computer services up to date.

It is an object of the present invention to provide personal computer services to home users without the burden re-purchasing new computer equipment at short intervals in order to keep up with the progress of computer technology.

It is an object of the present invention to provide personal computer services to home users, which allows the user to create a virtual PC with user selected performance characteristics, or to mimic certain user selected hardware configurations.

It is an object of the present invention to provide personal computer services to home users, which allows the user to create a virtual PC with user selected software titles.

These and other objects are accomplished by a home-based terminal having high-speed access to a remote virtual PC. The home-based terminal, or so-called bare-bones PC, includes a processor, which is capable of handling a high-speed data connection to a service provider. The home-based terminal would include typical user input/output devices, such as a keyboard, mouse, monitor, and printer, and could optionally include other peripheral devices, such as speakers, a scanner, and read/write drives for a diskette, CD, DVD, or memory card. The home user would instruct the service provider to construct a virtual PC having user selected hardware performance characteristics (e.g. processor class, processor speed, memory storage size and speed, graphics capabilities). Further, the home user would instruct the service provider to load, update and maintain user selected software titles (e.g. word processors, spread sheets, games). The service provider would charge a subscription fee or a usage fee. The home user would be alleviated of the software installation and maintenance burden, as well as benefit from the periodic data backups and virus protection from the service provider. Further, the home user's home-based PC would enjoy a much longer useful life.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 illustrates a system configuration of home-based terminals and a service provider's computer; and

FIG. 2 is a flow chart illustrating an initialization process for establishing a user's virtual PC.

### DETAILED DESCRIPTION OF A PREFERRED EMBODIMENT

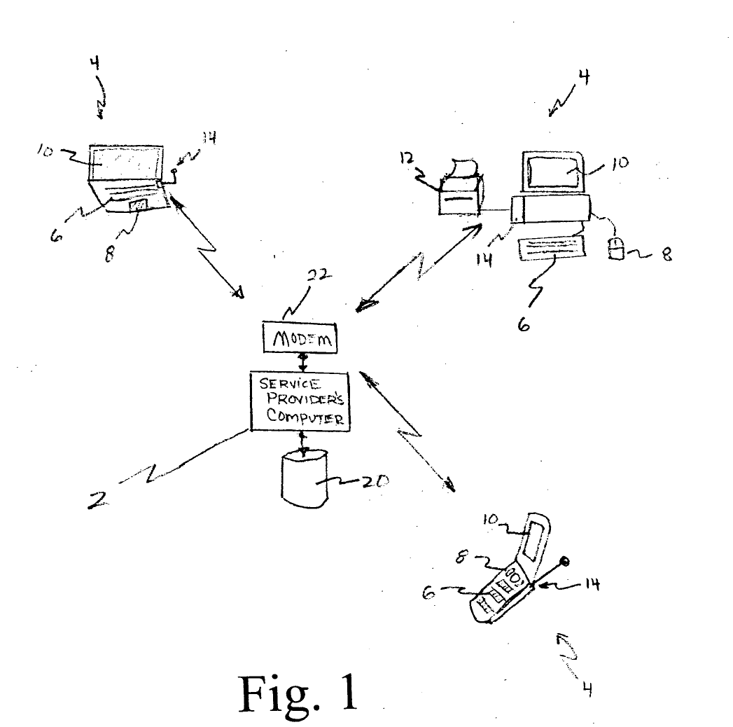

FIG. 1 illustrates a system configuration for a plurality of home-based terminals 4 and a service provider's computer 2. In FIG. 1, the service provider's computer 2 is connected to a plurality of home-based terminals 4. Although three home-based terminals 4 are illustrated, it should be appreciated that many hundreds of home-based terminals 4 could be connected to one service provider's computer 2. The plurality of home-based terminals 4 would be respectively placed in different households that could be located in different cities, states or even countries.

Each home-based terminal 4 would include common user input devices, such as a keyboard 6; mouse 8; joystick, microphone; scanner; and/or a CD, DVD, diskette or memory card reader. Also, each home-based terminal 4 would include common output devices, such as a monitor 10; speakers; printer 12; and/or a CD, DVD, diskette or memory card writer.

Each home-based terminal 4 would include a first processor and a first connection device 14, such as a modem for enabling high-speed communications with the service provider's computer 2. The modem could be of the DSL or cable modem types. Further, communications could occur over the Internet or a dedicated private or semi-private link.

The service provider's computer 2 includes at least one second processor. For example, the service provider's computer 2 might be a multi-processor system having a parallel processor configuration. Further, the service provider's computer 2 would include a mass memory 20 and a second connection device 22, such as a modem for communicating with the first connection device of the plurality of home-based terminals 4.

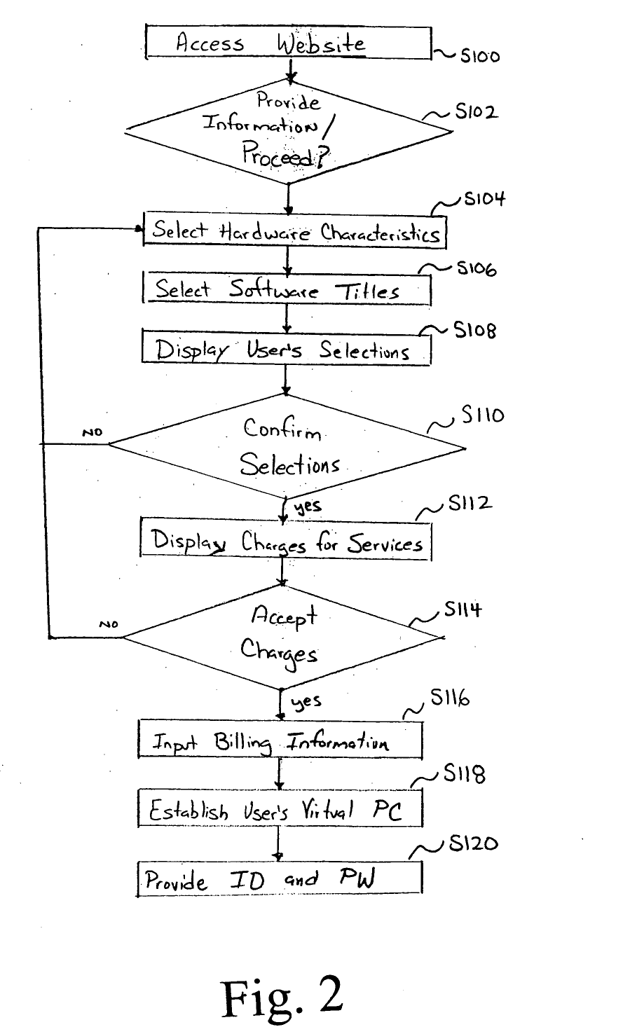

FIG. 2 is flowchart illustrating one embodiment of how a user of the home-based terminal 4 would establish a virtual PC at the service provider's computer 2. In step S100, the user accesses a website, hosted by the service provider's computer 2. In step S102, the user is provided with information about the virtual PC system, e.g. the potential abilities of the virtual PC, and the costs for subscription. Also, the user is provided with a menu option to confirm whether or not the user desires to configure a virtual PC. If so, the process proceeds to step S104.

In step S104, the user selects the desired performance characteristics of the virtual PC. For example, the user could select a processor class, a processor speed, a RAM size, a hard drive size, a graphics driver ability, etc. Different prices could be given for the various possible selections of these parameters. For example, the costs associated with configuring a virtual PC to have the performance characteristics of a PENTIUM IV processor class would be greater than the costs associated with configuring a virtual PC to have the performance characteristics of a PENTIUM III processor class. Likewise, the costs associated with configuring a virtual PC with a 200 GB hard drive would be greater that the costs associated with configuring a virtual PC with a 100 GB hard drive.

Next, in step S106, the user selects the desired software titles to be maintained on the virtual PC. For example, the user could select one or more word processors, spreadsheet programs, Internet browsers, document readers, digital photo processing programs, educational programs, games, etc. Different prices could be given for the various possible selections of software titles, and in particular monthly subscription fees for the software titles could be given. For example, the costs associated with configuring a virtual PC with the word processor WORD could be different than the costs associated with configuring the virtual PC with the word processor WORDPERFECT.

Next in step S108, the service provider's computer 2 displays a confirmation screen showing the user's selected hardware and software configurations. In step S110, the user is prompted to confirm the selections. If the selections are correct, the process proceeds to step S112. If the selections are incorrect, the process returns to step S104, and the user is given the opportunity to correct or change the hardware and software selections.

In step S112, the service provider's computer 2 provides the user with a cost for configuring the virtual PC with the user's selected hardware characteristics and software titles. The cost could be a periodic subscription rate, such as a monthly subscription rate. Alternatively, the cost could be based upon a usage of the virtual PC, such as a charge per gigabyte of storage space utilized on the service provider's mass memory 20. Alternatively, the charge could be based upon the amount of data exchanged with the virtual PC, such as a per gigabyte fee.

In step S114, the user is prompted to accept or reject the costs of the virtual PC. If the costs are not acceptable, the user may return to step S104 to reconfigure a less expensive virtual PC. If the costs are acceptable, the process proceeds to step S116.

In step S116, the user is prompted to input billing information. The billing information could include the user's name, mailing address, email address, telephone number and credit card information. It is also within the scope of the present invention that certain user demographic data would be solicited from the user. The demographic data could include the user's age, marital status, occupation, income level, education level, hobbies and interests, etc.

Next, in step S118, the service provider's computer 2 establishes a virtual PC for access by the user. In step S120, the user is provided with an account number and password to permit future secure access to the virtual PC, twenty-four hours a day, seven days a week. By using an account number and password, the virtual PC could be accessed not only from the user's home-based terminal or PC, but also at remote locations, such as hotels and airports, by another a computer, a laptop, a PDA, a cellular phone, and other such devices having an ability to connect to the service provider's computer 2. Of course, the account number and password could be customizable by the user.

Although the present invention has been described in relation to a virtual PC which permits a user to select desired hardware characteristics and software titles, variations on this theme are within the scope of the present invention. For example, it is within the purview of the present invention that the hardware characteristics of the virtual PC could be fixed for all users. For example, the service provider's computer 2 could provide a virtual PC to all user's having the performance characteristics of a Pentium IV class processor running at 4 GHz, with a 100 gigabyte hard drive. Under such an example, the user would only selected the desired software titles to be utilized by the virtual PC.

As another example, the software titles for the virtual PC could be fixed for each of the virtual PCs hosted by the service provider's computer 2. The user would only select the hardware performance characteristics for the virtual PC. Such an arrangement might lead to economies of scale for the service provider in obtaining favorable terms in software license agreements.

As mentioned above in step S116, the service provider could collect demographic data from the users of the virtual PC system. This demographic data could be used by the service provider to offer trial subscriptions to software titles of interest to particular users. For example, the service provider might offer a one month subscription to a software gaming program relating to football for a person who listed football as a favorite interest or hobbies. Moreover, it is envisioned that the service provider would be constantly offering trial subscriptions to various software programs, and that the user of the virtual PC would enjoy looking through the virtual PC hosting website to view all of the new and changing software titles, which were available to be utilized on their virtual PC. Most software titles could be offered with a free trial period.

The virtual PC environment would be highly desirable to software manufacturers since their software would be exposed to many potential customers, via the virtual PC service provider's website. Further, there would be a decreased likelihood of software pirating since the software would not actually be stored on a memory or medium within the possession of the user. Rather, the software program would be stored in the mass memory 20 of the service provider's computer 2, and if desirable strict precautions could be taken to prevent downloading of the actual software programs to the home-based terminals 4.

Additional features could be employed in conjunction with the virtual PC, as described above. For example, movies on demand could be hosted by the service provider, such that user's could purchase and view a variety of movies via their virtual PC. Also, telephone services, such as voice over Internet (VoIP) could be made available. Such supplemental services could be part of a total monthly package plan, e.g. unlimited local and long distance calling, ten free movies, and unlimited virtual PC usage for a monthly fee. Alternatively, the various services could be purchased individually.

It would be the service provider's responsibility to make sure that the user's selected software titles are kept up to date. In this regard, the service provider would update the software titles immediately, as new updates become available from the manufacture, or periodically evaluate each software title, making all of the updates on periodic basis.

Further, it would be the responsibility of the service provider to make data backups of the mass memory 20 on a periodic basis. For example, backups of the mass memory 20 could occur nightly and be maintained for a period of two weeks. Should a subscriber need to have data restored, the subscriber could contact the service provider, confirm their identity, and ask to have the data restored. This service could be provided for a fee, or as part of the subscription plan.

Also, it would be the responsibility of the service provider to maintain up-to-date professional protection against viruses, worms and other such hacker attacks. The service provider would be responsible to maintain and update a virus protection program and firewall program, which would provide the subscribers with a high level of security against such threats.

By the invention, it will be possible for a subscriber to keep their existing hardware or home-based PC for a much longer time than previously possible. This is because the home-based PC need only have the technology-based ability to handle a high-speed connection to the service provider. There is no need for the user to replace their home-based PC in order to gain access to a faster or higher level processor, or to replace the home-based PC when more hard drive storage is needed. A environmental benefit of the present invention is a reduction of outdated PCs being sent to waste fields. Further, the present invention would be particularly beneficial in economically depressed areas or foreign countries. The present invention would enable lower income homes to afford high-end computer resources without actually having a high-end home PC.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed:

1. A method of operating a service provider's computer to provide computer services to a home-based terminal, said method comprising the steps of:
receiving subscription information from the home-based terminal specifying that a home user desires to configure a virtual personal computer (PC);
receiving configuration information from the home-based terminal specifying PC hardware characteristics desired by a user of the home-based terminal;
configuring a virtual PC within the service provider's computer, which mimics the PC hardware characteristics desired by the user of the home-based terminal; and
making the virtual PC available to the user over a high-speed connection to the home-based terminal.

2. The method of claim 1, wherein the hardware characteristics are performance characteristics and include at least one of a processor class, a processor speed, a RAM memory size, and a hard drive memory size.

3. The method of claim 1, further comprising:
protecting the user's virtual PC with a virus and/or firewall protection software; and
automatically updating the virus and/or firewall software.

4. The method of claim 1, further comprising:
monitoring a user's interaction with the user's virtual PC; and
charging the user based upon a level of usage of the user's virtual PC or periodically.

5. The method of claim 4, wherein the level of usage is based upon a storage space consumed in the service provider's computer memory, or a size of data sent to, or downloaded from, the user's virtual PC.

6. The method of claim 1, further comprising:
creating a backup the user's data stored in the service provider's computer memory on a periodic basis, and maintaining the backup for a preset period of time.

7. The method of claim 6, wherein the backup of the user's data is created on a daily basis.

8. A method of operating a service provider's computer to provide computer services to a home-based terminal, said method comprising the steps of:
receiving subscription information from the home-based terminal specifying that a home user desires to configure a virtual personal computer (PC);
receiving software information from the home-based terminal specifying at least one title of software that the home user desires to install on the virtual PC;
configuring a virtual PC within the service provider's computer, wherein the virtual PC is enabled to utilize the at least one software title desired by the user of the home-based terminal; and
making the virtual PC available to the user over a high-speed connection to the home-based terminal.

9. The method of claim 8, further comprising:
automatically updating the at least one software title, whenever an update for the at least one software title becomes available.

10. The method of claim 8, further comprising:
periodically reviewing the at least one software title and updating the at least one software title whenever an update is available.

11. The method of claim 8, further comprising:
protecting the user's virtual PC with a virus and/or firewall protection software; and
automatically updating the virus and/or firewall software.

12. The method of claim 8, further comprising:
monitoring a user's interaction with the user's virtual PC; and
charging the user based upon a level of usage of the user's virtual PC or periodically.

13. The method of claim 12, wherein the level of usage is based upon a storage space consumed in the service provider's computer memory, or a size of data sent to, or downloaded from, the user's virtual PC.

14. The method of claim 8, further comprising:
creating a backup the user's data stored in the service provider's computer memory on a periodic basis, and maintaining the backup for a preset period of time.

15. The method of claim 14, wherein the backup of the user's data is created on a daily basis.

16. A method of operating a service provider's computer to provide computer services to a home-based terminal, said method comprising the steps of:
receiving subscription information from the home-based terminal specifying that a home user desires to configure a virtual personal computer (PC);
receiving configuration information from the home-based terminal specifying PC hardware characteristics desired by a user of the home-based terminal;
receiving software information from the home-based terminal specifying at least one title of software that the home user desires to install on the virtual PC;
configuring a virtual PC within the service provider's computer, which mimics the PC hardware characteristics desired by the user of the home-based terminal, wherein the virtual PC is enabled to utilize the at least one software title desired by the user of the home-based terminal; and
making the virtual PC available to the user over a high-speed connection to the home-based terminal.

17. The method of claim 16, wherein said step of receiving subscription information includes receiving a user's name, address and payment information.

18. A service provider's computer configured to represent a virtual personal computer for access by a home-based terminal, said computer comprising:
means for receiving subscription information from the home-based terminal specifying that a home user desires to configure a virtual personal computer (PC);
means for receiving configuration information from the home-based terminal specifying PC hardware characteristics desired by a user of the home-based terminal;
means for configuring a virtual PC within the service provider's computer, which mimics the PC hardware characteristics desired by the user of the home-based terminal; and
means for making the virtual PC available to the user over a high-speed connection to the home-based terminal.

19. The service provider's computer of claim 18, wherein said means for making the virtual PC available to the user includes a high-speed Internet connection.

20. A service provider's computer configured to represent a virtual personal computer for access by a home-based terminal, said computer comprising:
means for receiving subscription information from the home-based terminal specifying that a home user desires to configure a virtual personal computer (PC);
means for receiving software information from the home-based terminal specifying at least one title of software that the home user desires to install on the virtual PC;
means for configuring a virtual PC within the service provider's computer, wherein the virtual PC is enabled to utilize the at least one software title desired by the user of the home-based terminal; and
means for making the virtual PC available to the user over a high-speed connection to the home-based terminal.

21. The service provider's computer of claim 20, wherein said means for making the virtual PC available to the user includes a high-speed Internet connection.

22. The service provider's computer of claim 20, further comprising:
means for receiving configuration information from the home-based terminal specifying PC hardware characteristics desired by a user of the home-based terminal; and
means for configuring a virtual PC within the service provider's computer, which mimics the PC hardware characteristics desired by the user of the home-based terminal.

23. The service provider's computer of claim 22, wherein said means for making the virtual PC available to the user includes a high-speed Internet connection.
